(19) United States
(12) Patent Application Publication
(10) Pub. No.: US 2006/0006981 A1
(43) Pub. Date: Jan. 12, 2006

(54) Resistor element with uniform resistance being independent of process variations, semiconductor integrated circuit device having the same, and fabrication methods thereof

(76) Inventors: Hyeoung-won Seo, Yongin-si (KR); Sun-joon Kim, Yongin-si (KR); Shang-kyu Shin, Suwon-si (KR); Hyun-chang Kim, Suwon-si (KR)

Correspondence Address: LEE & MORSE, P.C.;Attorneys and Counselors At Law, SUITE 2000, 1101 WILSON BOULEVARD, ARLINGTON, VA, 22209, US

(21) Appl. No.: 11/175,431

(22) Filed: Jul. 7, 2005

(30) Foreign Application Priority Data
Jul. 8, 2004 (KR) 10-2004-0053068

(51) Int. Cl. H01C 1/01

(52) U.S. Cl. 338/320

(57) ABSTRACT

Provided is a resistor element including a resistor formed on an insulating layer, and a complementary resistor formed on the insulating layer and insulated from the resistor, the complementary resistor electrically connected in parallel to the resistor, wherein a resistance of the complementary resistor is complementary to a resistance of the resistor. A semiconductor integrated circuit device including the resistor element, and methods of fabricating the resistor element and the semiconductor integrated circuit device are also provided.

### BACKGROUND OF THE INVENTION

1. Field of the Invention

The present invention relates to a resistor element with uniform resistance being relatively independent of process variations, a semiconductor integrated circuit device including the resistor element, and methods of fabricating the resistor element and the semiconductor integrated circuit device.

2. Description of the Related Art

Continuing efforts to increase the level of integration of semiconductor integrated circuits are directed to allowing active and passive elements constituting the semiconductor integrated circuits to be continuously scaled down. Further, high performance elements with more elaborate characteristics are increasingly required for low power consumption and high-speed semiconductor devices. Specifically, in order to satisfy high-speed characteristics, it may be a challenge to control characteristics of individual elements substantially uniformly.

For a resistor element, which is a passive element, its width versus resistance relationship is shown in FIG. 1. Referring to FIG. 1, even when a variation (dispersion) dW for a width W of a resistor element is a constant, a resistance variation 2dR in a section (b) in which the width W of the resistor element is relatively small is much larger than a resistance variation dR in a section (a) in which the width W of the resistor element is relatively large. In other words, where a resistor manufacturing process yields a constant deviation dW in a resistor width W, resistors manufactured by that process may exhibit variable resistance values, i.e., from dR to 2dR or more. Thus, controlling a variation in resistor width may not, by itself, be sufficient to yield consistent resistance values.

In order to meet high integration requirements, methods of formation of a resistor elements having reduced width have been developed. However, the resistance thereof may vary significantly with process variations and may be more sensitive to process variations than conventional resistor elements. Accordingly, resistor elements have become critically important in determining device characteristics.

### SUMMARY OF THE INVENTION

The present invention is therefore directed to a device having uniform resistance, and more particularly, to a resistor element that has a resistance that is relatively independent of process variations, integrated circuit devices having the same, and fabrication methods thereof, which substantially overcome one or more of the problems due to the limitations and disadvantages of the related art.

It is therefore a feature of an embodiment of the present invention to provide a resistor element having a resistance that is relatively unaffected by process variations.

It is therefore another feature of an embodiment of the present invention to provide a resistor element including a resistor electrically connected in parallel to a complementary resistor, the complementary resistor formed adjacent to the resistor and having a resistance that is complementary to a resistance of the resistor.

At least one of the above and other features and advantages of the present invention may be realized by providing a resistor element including a resistor formed on an insulating layer, and a complementary resistor formed on the insulating layer and insulated from the resistor, the complementary resistor electrically connected in parallel to the resistor, wherein a resistance of the complementary resistor is complementary to a resistance of the resistor.

The resistor element may be adjacent to the resistor, and the complementary resistor and the resistor may be formed of materials having substantially the same resistivity, such that a variation in a width of the resistor produces a complementary variation in a width of the complementary resistor but does not produce a variation in resistance of the resistor element.

At least one of the above and other features and advantages of the present invention may also be realized by providing a semiconductor device including a plurality of resistor elements, the plurality of resistor elements including resistors formed on an insulating layer and separated from each other by a constant pitch, and complementary resistors formed adjacent to the resistors, wherein each complementary resistor has a width that is complementary to a width of an adjacent resistor and is electrically connected in parallel to the adjacent resistor.

Each of the plurality of resistor elements may include a resistor and a complementary resistor having substantially the same resistivity, having substantially the same height and/or having substantially the same length. Each of the plurality of resistor elements may include a resistor and a complementary resistor that are electrically connected in parallel by way of contact holes formed at lengthwise opposite ends of the resistor and the complementary resistor.

The semiconductor device may also include a conductive spacer encircling and insulated from the plurality of resistor elements, a dummy resistor formed adjacent to a complementary resistor, wherein the dummy resistor does not constitute a resistor element and/or two outermost resistors and a complementary resistor adjacent to one of the two outermost resistors, wherein the two outermost resistors and the complementary resistor adjacent to one of the two outermost resistors are dummy resistors that do not constitute a resistor element.

At least one of the above and other features and advantages of the present invention may further be realized by providing a semiconductor integrated circuit device that may include a semiconductor substrate having a cell array area and a peripheral circuit area, and a plurality of resistor elements formed on an insulating layer of the peripheral circuit area, the plurality of resistor elements including resistors separated from each other by a constant pitch, and complementary resistors formed adjacent to the resistors, wherein each complementary resistor has a width that is complementary to a width of an adjacent resistor and is electrically connected in parallel to the adjacent resistor.

The cell array area may further include a cell capacitor, wherein a plate electrode of the cell capacitor and the resistors and/or the complementary resistors may be formed on a same interlayer insulating film.

The semiconductor integrated circuit device may have a plurality of resistor elements, wherein each includes a resistor and a complementary resistor having substantially the same length. Each of the plurality of resistor elements may include a resistor and a complementary resistor that are electrically connected in parallel by way of contact holes formed at lengthwise opposite ends of the resistor and the complementary resistor. The semiconductor integrated circuit device may also include a conductive spacer encircling and insulated from the plurality of resistor elements, a dummy resistor formed adjacent to a complementary resistor, wherein the dummy resistor does not constitute a resistor element and/or two outermost resistors and at least one complementary resistor adjacent to one of the two outermost resistors, wherein the two outermost resistors and at least one complementary resistor adjacent to one of the two outermost resistors are dummy resistors that do not constitute a resistor element.

At least one of the above and other features and advantages of the present invention may also be realized by providing a method of fabricating a resistor element, the method including providing a substrate having an insulating layer thereon, and forming a plurality of resistor elements, wherein the plurality of resistor elements may include resistors formed on the insulating layer and separated from each other by a constant pitch, and complementary resistors formed adjacent to the resistors, wherein each complementary resistor has a width that is complementary to a width of an adjacent resistor and is electrically connected in parallel to the adjacent resistor.

At least one of the above and other features and advantages of the present invention may further be realized by providing a method of fabricating a semiconductor integrated circuit device, the method including providing a semiconductor substrate having a cell array area and a peripheral circuit area, and forming a plurality of resistor elements on an insulating layer in the peripheral circuit area, wherein the plurality of resistor elements may include resistors formed on the insulating layer and separated from each other by a constant pitch, and complementary resistors formed adjacent to the resistors, wherein each complementary resistor has a width that is complementary to a width of an adjacent resistor and is electrically connected in parallel to the adjacent resistor.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a relationship between width and resistance of a resistor element;

FIG. 2 illustrates a perspective view of a resistor element, according to a first embodiment of the present invention;

FIG. 3 illustrates an equivalent circuit diagram of the resistor element of FIG. 2;

FIG. 4 illustrates a cross-sectional view taken along lines A-A′ and B-B′ of FIG. 2;

FIG. 5 illustrates a perspective view of a resistor element, according to a second embodiment of the present invention;

FIG. 6 illustrates a cross-sectional view taken along lines A-A′ and B-B′ of FIG. 5;

FIG. 7 illustrates a cross-sectional view of a resistor element, according to a third embodiment of the present invention;

FIG. 8 illustrates a cross-sectional view of a resistor element, according to a fourth embodiment of the present invention;

FIG. 9 illustrates a plan view of a resistor element, according to a fifth embodiment of the present invention;

FIG. 10 illustrates a cross-sectional view taken along lines A-A′, B-B′ and C-C′ of FIG. 9;

FIGS. 11 through 19B illustrate stages in a method of fabricating a resistor element, according to the first and third embodiments of the present invention;

FIGS. 20 through 22 illustrate cross-sectional views of stages in a method of fabricating a resistor element, according to the fourth embodiment of the present invention;

FIGS. 23A through 26B illustrate stages in a method of fabricating the resistor element according to the fifth embodiment of the present invention; and

FIGS. 27 through 32 illustrate cross-sectional views in stages of a method of fabricating a semiconductor integrated circuit device including a resistor element according to embodiments of the present invention.

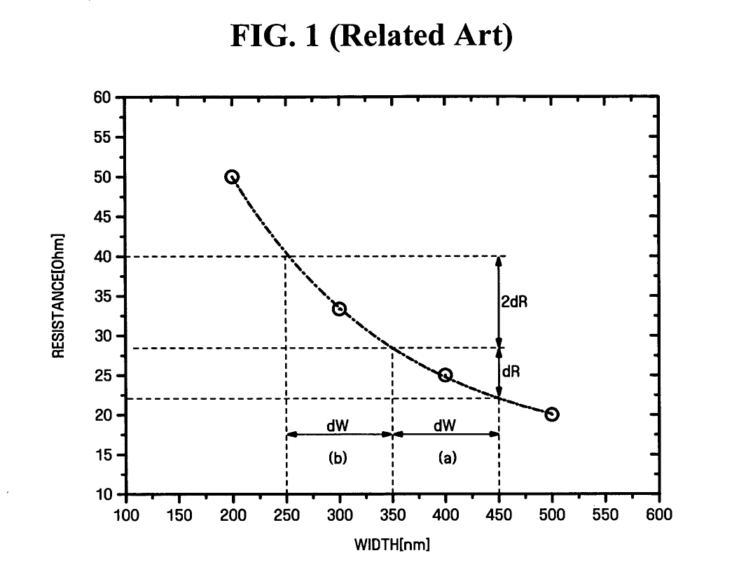

### DETAILED DESCRIPTION OF THE INVENTION

Korean Patent Application No.10-2004-0053068, filed on Jul. 8, 2004, in the Korean Intellectual Property Office, and entitled: “RESISTOR ELEMENT WITH UNIFORM RESISTANCE BEING INDEPENDENT UPON PROCESS VARIATIONS, SEMICONDUCTOR INTEGRATED CIRCUIT DEVICE HAVING THE SAME, AND FABRICATION METHODS THEREOF,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. In describing aspects of the present invention, “thickness” generally refers to the thickness of a layer or bulk material and “height” generally refers to a height of a feature formed from the layer or bulk material. Thus, the height of a feature may typically be related to the thickness of the layer or bulk material from which it was formed. However, these distinctions are used simply for clarity of description and illustration, and do not limit the present invention. Further, “thickness” and “height” may be used interchangeably. Like reference numerals refer to like elements throughout.

Embodiments of the present invention will be described with respect to resistor elements that may exhibit uniform resistance regardless of process variations, i.e., to resistor elements with resistance being relatively independent of process variations. Resistor elements according to embodiments of the present invention may include pairs of resistors and complementary resistors, which may be capable of compensating for a variation in a width of the resistors. A complementary resistor may exhibit a complementary resistance to a resistance of a resistor, such that a width variation in a width of the resistor produces an opposite width variation in a width of the complementary resistor, and, thus, a resistance variation in a resistor produces an opposite (i.e., complementary) resistance variation in the complementary resistor. Effects of a resistor width variation on the resistance of the resistor elements may be reduced or eliminated by connecting the resistors with the complementary resistors in parallel, as the resistance of a parallel-connected resistor pair is equal the reciprocal of the sum of the reciprocals of the resistors.

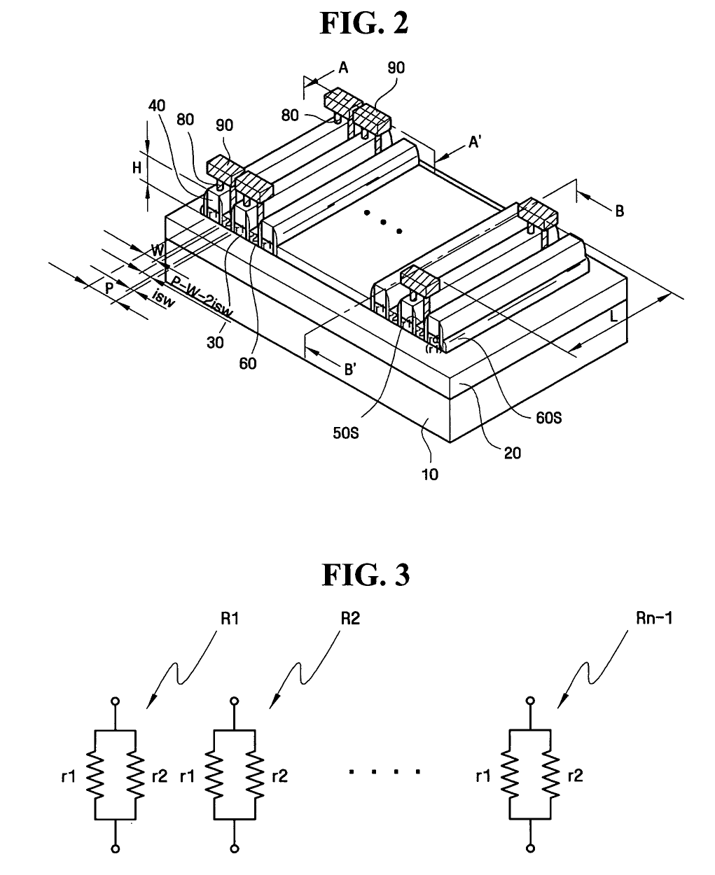

Resistor elements according to the embodiments of the present invention will be best understood with reference to FIGS. 2 through 10.

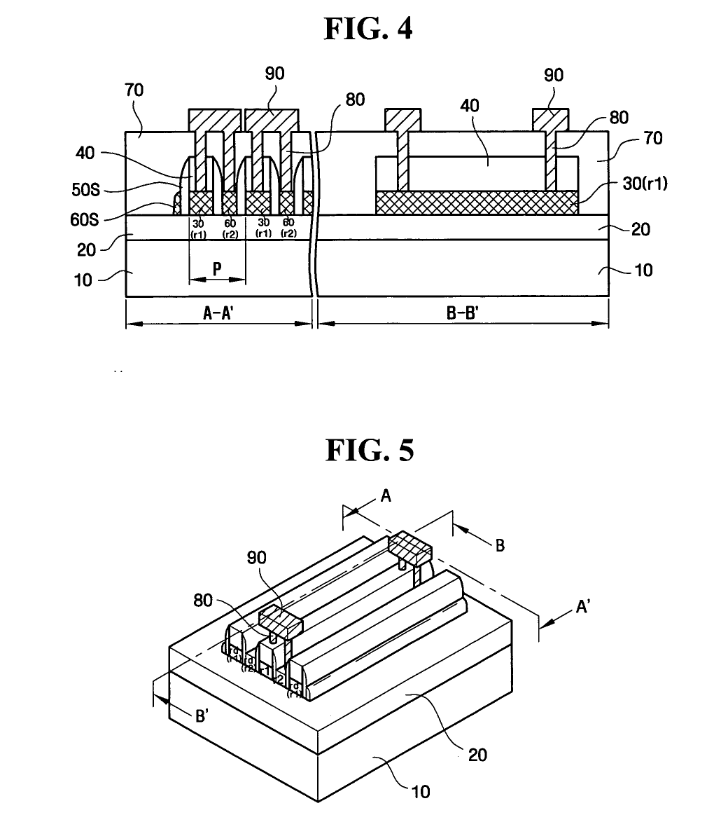

FIG. 2 illustrates a perspective view of a resistor element, according to a first embodiment of the present invention, FIG. 3 illustrates an equivalent circuit diagram of the resistor element of FIG. 2 and FIG. 4 illustrates a cross-sectional view taken along lines A-A′ and B-B′ of FIG. 2.

FIGS. 2 through 4 illustrate n-1 resistor elements R1, R2, . . . , Rn-1. Each of the resistor elements R1, R2, . . . , Rn-1 includes a resistor pair composed of a resistor r1 and a complementary resistor r2. For example, resistor element R1 includes resistor r1 and complementary resistor r2. A number n of resistors r1, 30, may be formed on an insulating layer 20 covering a substrate 10 as n bar patterns arranged in a predetermined pitch P. A number n-1 of complementary resistors r2, 60, may be formed in a self-aligned manner in spaces between each of the n resistors r1 in such a way that they are insulated from the resistors r1 by an insulating spacer 50S and arranged in parallel with the resistors r1. In this regard, assuming that the width of each resistor r1 is W and the width of the insulating spacer 50S is isw, the width of each complementary resistor r2 is equal to P−W−2isw. An insulating mask 40 to define each resistor r1 may remain on an upper surface of each resistor r1. The insulating mask 40 may facilitate formation of the complementary resistors (a detailed description of the insulating mask 40 will be provided below, in the context of a method of fabricating a resistor element). When the insulating mask 40 remains, the insulating spacer 50S may be formed on sidewalls of the resistors and the insulating mask 40.

A parallel-connection contact 80 may be formed on both upper ends in the lengthwise direction L of the resistors and the complementary resistors in such a way as to be bored through the insulating mask 40 and an interlayer insulating film 70. The parallel-connection contact 80 may also be formed as a simultaneous contact with the resistors and the complementary resistors. Connection of the resistors and the complementary resistors to a parallel-connection node wire 90, via the parallel-connection contact 80, may be used to complete fabrication of the resistor elements R1, R2,. . . , Rn-1.

In above-described resistor element structure, the last resistor may be a dummy resistor rd that does not constitute a resistor element. A conductive spacer 60S made of the same material as the complementary resistors and insulated from the complementary resistors may be formed on sidewalls of the leftmost resistor r1 and the rightmost resistor, i.e., the dummy resistor rd (a detailed description thereof will be provided below, in the context of a method of fabricating a resistor element).

In the resistor elements R1, R2,. . . , Rn-1 according to the illustrative embodiment of the present invention, the complementary resistors r2 may compensate for a variation in the width of the resistors r1. In detail, when the width W of the resistors r1 is changed to W+dW due to a width variation dW, e.g., during a photolithography process, the width of the complementary resistors r2 may concomitantly change from P−W−2isw to P−(W+dW)−2isw. That is, the width of the complementary resistors r2 after the width variation dW of the resistors may be dW smaller than that before the width variation dW of the resistors r1. The width of the complementary resistors r2 may be reduced by an increase dW in the width of the resistors r1. Conversely, when the width of the resistors is reduced by dW, the width of the complementary resistors may be increased by dW.

As in the first embodiment of the present invention, a parallel connection between the resistors and the complementary resistors may enable the resistor elements R1, R2, . . ., Rn-1 to eliminate an effect of a width variation dW on resistance. A resistance R of each of the resistor elements R1, R2, . . ., Rn-1, composed of the resistors and the complementary resistors connected in parallel, is given as:

$$\frac{1}{R} = \{ \frac{1}{r1} \} + \{ \frac{1}{r2} \} \\ = \{ \frac{1}{ρ L / WH} \} + \{ \frac{1}{{ρ}^{′} {L}^{′} / ( P - W - 2 isw ) {H}^{′}} \} \\ = \frac{W ( H {ρ}^{′} {L}^{′} - {H}^{′} ρ L ) + ( P - 2 isw ) {H}^{′} ρ L}{ρ L {ρ}^{′} {L}^{′}} \qquad [ Equation 1 ]$$

where P is a pitch of the resistors, isw is a width of the insulating spacer 50S, H and H′ are sectional heights of each resistor r1 and each complementary resistor r2, respectively, ρ and ρ′ are resistivities of each resistor r1 and each complementary resistor r2, respectively and L and L′ are lengths of each resistor r1 and each complementary resistor r2, respectively.

If the resistors and the complementary resistors are the same, or have an insignificant difference or are substantially the same, in terms of resistivity, height and length, the resistance R of each resistor element can be simplified to:

$$R = \frac{ρ L}{( P - 2 isw ) H} \qquad [ Equation 2 ]$$

As seen from Equation 2, when the resistors and the complementary resistors are connected in parallel, an effect of a width variation dW on resistance may be reduced or eliminated where the resistivity, height and length of each resistor-complementary resistor pair is substantially the same. With respect to the other parameters that may affect the resistance R, the pitch P is a constant, the width isw of the insulating spacer 50S is a value determined by a deposition process and an etching process, ensuring that any width variation is approximate to zero, and the height H of the resistors and the complementary resistors is a value determined by a deposition process, ensuring that any height variation is approximate to zero. With respect to the length L of the resistors and the complementary resistors, a length variation may occur due to a photolithography process. However, the length L of the resistors and the complementary resistors is sufficiently large so that an effect of a length variation on the resistance R is insignificant, in contrast to the effect of a width variation on the resistance R of the resistors and the complementary resistors. Therefore, the resistance R of the resistor elements may be maintained relatively uniform.

As described above in the simplification from Equation 1 to Equation 2, the resistors and the complementary resistors may have substantially the same resistivity (ρ). Further, the resistors and the complementary resistors may have substantially the same height (H). Thus, upper and lower surface levels of the resistors r1 may be the same as those of the complementary resistors r2.

To obtain a large resistance value, the width isw of the insulating spacer 50S between each resistor r1 and each complementary resistor r2 may be as small as practicable.

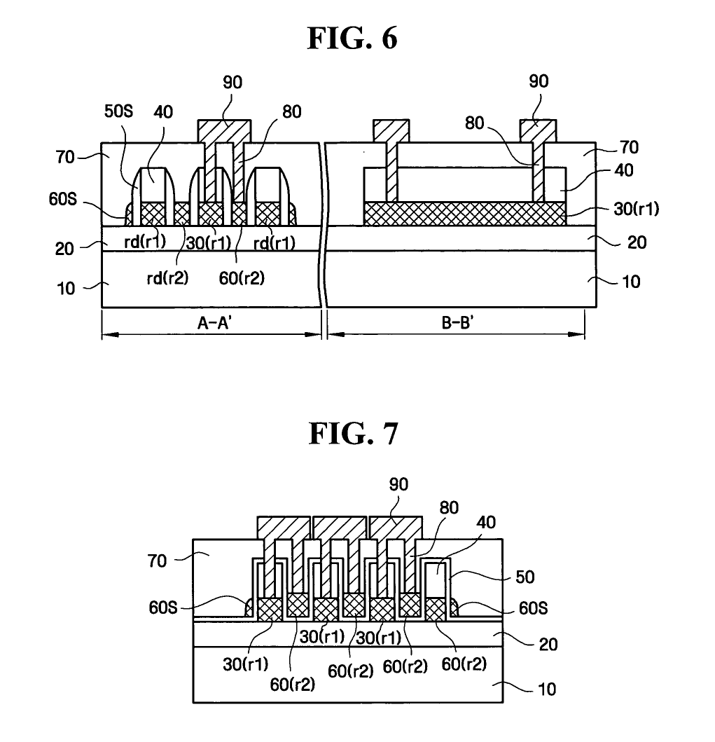

FIG. 5 illustrates a perspective view of a resistor element, according to a second embodiment of the present invention and FIG. 6 illustrates a cross-sectional view taken along lines A-A′ and B-B′ of FIG. 5.

Referring to FIGS. 5 and 6, two outermost resistors and one of two complementary resistors adjacent to the two outermost resistors may be used as dummy resistors (each of which is denoted rd), in which case they would not constitute a resistor element. These resistors may be used as dummy resistors because the two outermost resistors may undergo a larger width variation and/or have a smaller width, e.g., due to a loading effect during a photolithography process, as compared to inner resistors. That is, a resistor element having a higher level of uniformity in resistance may be obtained by constructing the resistor element as shown in FIGS. 5 and 6, wherein the dummy resistors rd do not constitute a resistor element. The same components as those in the first embodiment are identified by the same reference numerals, and hence a detailed explanation thereof need not be repeated.

While only one resistor element is illustrated in FIG. 5, it will be understood by those of ordinary skill in the art that the dummy resistor array of the second embodiment may also be applied to a plurality of resistor elements, as in the first embodiment. In detail, assuming that n resistors and n-1 complementary resistors, formed in spaces between the resistors, are arranged according to the second embodiment, then n-2 resistor elements may be fabricated, since two outermost resistors and one of two complementary resistors adjacent to the two outermost resistors may be used as dummy resistors.

FIG. 7 illustrates a cross-sectional view of a resistor element, according to a third embodiment of the present invention.

Referring to FIG. 7, the third embodiment is different from the first embodiment in that resistors r1 and complementary resistors r2 may be insulated from each other by a capping insulating film 50, rather than by an insulating spacer (see 50S of FIG. 4). The capping insulating film 50 may be conformally formed to the shapes of the resistors r1 and insulating masks 40 formed on the resistors r1. This embodiment is advantageous in that the capping insulating film 50 may be used directly, without having to perform an etching process for formation of an insulating spacer (see 50S of FIG. 4), in contrast to the first embodiment.

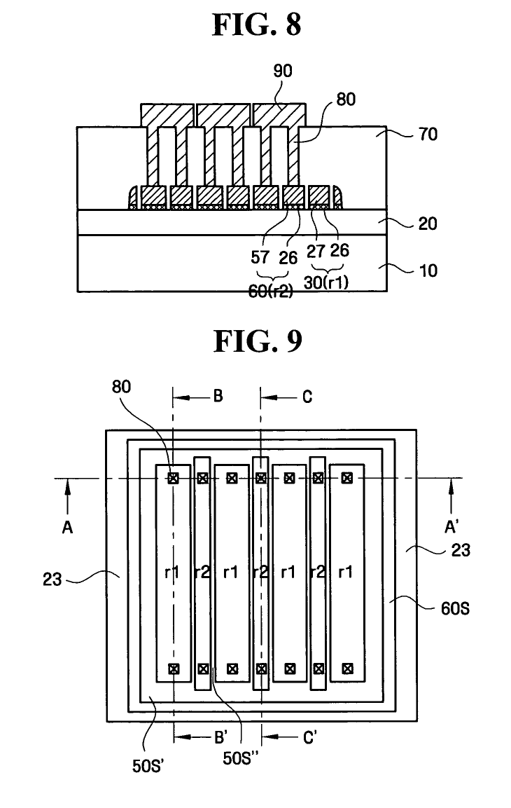

FIG. 8 illustrates a cross-sectional view of a resistor element, according to a fourth embodiment of the present invention.

Referring to FIG. 8, the fourth embodiment is different from the first through third embodiments in that neither insulating spacer nor capping insulating film are present and resistors r1 and complementary resistors r2 may be insulated only by an interlayer insulating film 70. According to the fourth embodiment, each of the resistors r1 may be composed of two conductive films 26 and 27 and each of the complementary resistors r2 may be composed of two conductive films 26 and 57. This structure may be used when the resistors r1 and the complementary resistors r2 are formed in the same pattern using two-layer conductive layers 26/27 and 26/57.

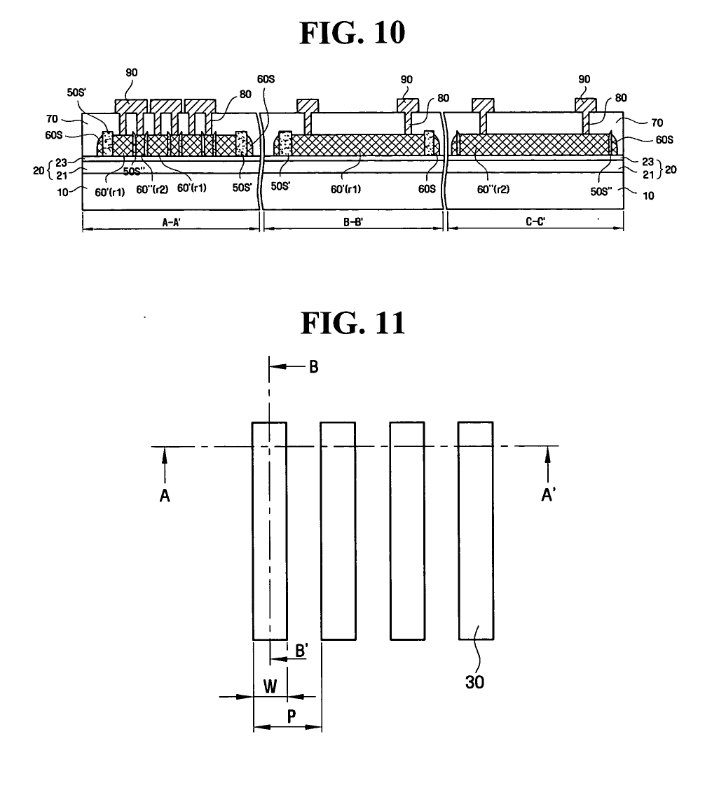

FIG. 9 illustrates a plan view of a resistor element, according to a fifth embodiment of the present invention and FIG. 10 illustrates a cross-sectional view taken along lines A-A′, B-B′ and C-C′ of FIG. 9.

Referring to FIGS. 9 and 10, the fifth embodiment is different from the first embodiment in that resistors r1 and complementary resistors r2 are enclosed by first and second insulating spacers 50S′ and 50S″ in the form of rim type spacers. The width of the first insulating spacer 50S′, formed on lengthwise opposite ends of each of the resistors r1, may be greater than that of the second insulating spacer 50S″, which is formed on sidewalls of each of inner resistors and on lengthwise opposite ends of each of the complementary resistors r2. In addition, the lengths of the complementary resistors r2 may be greater than those of the resistors r1. A length difference between the resistors r1 and the complementary resistors r2 may be substantially the same as a width difference between the first and second insulating spacers 50S′ and 50S″. As another exemplary rim-type spacer, a conductive spacer 60S may be formed along the entire outer periphery of the first and second insulating spacers 50S′ and 50S″. The fifth embodiment is also different from the first through fourth embodiments in that two insulating layers having different etch rates, i.e., lower and upper insulating layer 21 and 23, may be formed underneath the resistors r1 and the complementary resistors r2. The upper insulating layer 23 may serve as an etch stop layer.

Hereinafter, methods of fabricating the resistor elements according to embodiments of the present invention will be described.

FIGS. 11 through 19B illustrate stages in a method of fabricating a resistor element, according to the first and third embodiments of the present invention, and illustrate resistor elements composed of four resistors r1. In the respective drawings, the right side drawings illustrate the first (1) embodiment and the left side drawings illustrate the third (3) embodiment, as indicated by the reference numerals 1 and 3, respectively.

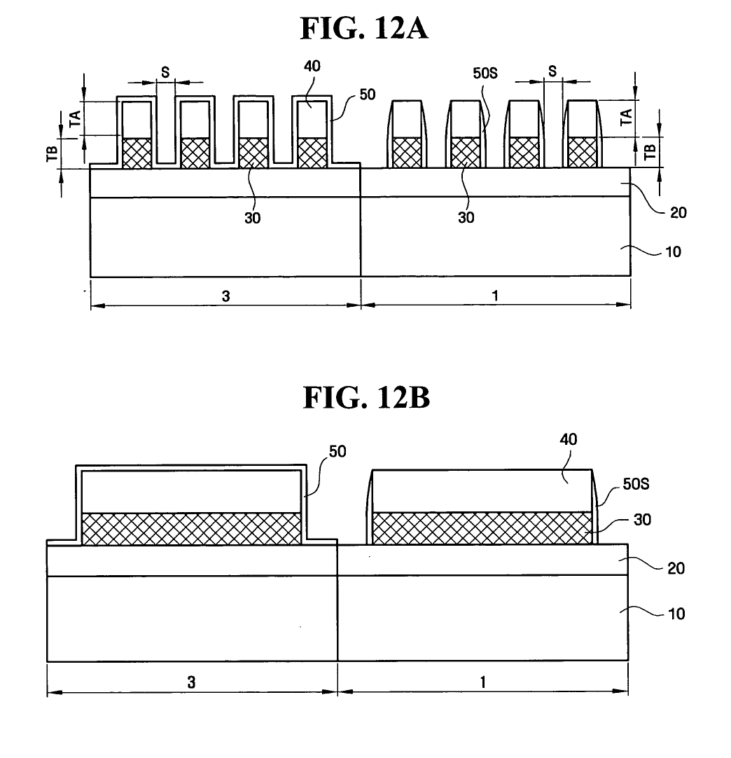

Resistors may be formed in a bar pattern, and FIG. 11 illustrates a plan view of bar pattern type resistors. FIGS. 12A and 12B illustrate, respectively, cross-sectional views taken along lines A-A′ and B-B′ of FIG. 11.

Referring to FIGS. 11-12B, four bar pattern type resistors 30 may be formed to a predetermined width W and a predetermined thickness TB on an insulating layer 20 covering a substrate 10, and may be separated from each other by a predetermined pitch P. These bar pattern type resistors 30 may be formed with an insulating mask 40 thereon, e.g., by sequentially forming a conductive film and an insulating film on the insulating layer 20, followed by patterning. The resistors 30 may be formed of a single-layered conductive film or a multi-layered conductive film. The conductive film may be a doped polysilicon film, a metal film, or a stacked film of a metal film and a doped polysilicon film. The metal film may be formed using various metal materials, including, e.g., TiN, Ti, Al, W, or Cu.

The insulating mask 40 may be made of a material having a good etching selectivity, relative to a material constituting an insulating spacer 50S. For example, when the insulating spacer 50S is made of nitride, the insulating mask 40 may be formed of oxide. Note that when determining the thickness TA of the insulating mask 40, a formation process for a conductive film (to be subsequently formed into complementary resistors) may be taken into consideration (a detailed description thereof will later be provided; see Equation 3).

A capping insulating film 50 or the insulating spacer 50S may be formed to insulate the resistors 30 and complementary resistors (complementary resistors are to be formed in a subsequent process). The capping insulating film 50 may be conformally formed to the shapes of the insulating mask 40 and the resistors 30. The capping insulating film 50 may be formed as thinly as practicable, within permissible process margins, and provided that electrical insulation between the resistors 30 and the complementary resistors, to be formed later, is ensured. For example, the capping insulating film 50 may be formed to a thickness of 100 nm or less, more preferably 50 nm or less. In the first embodiment, the capping insulating film 50 may be etched to form the insulating spacer 50S on sidewalls of the insulating mask 40 and the resistors 30. In the third embodiment, the capping insulating film 50 may be left unetched.

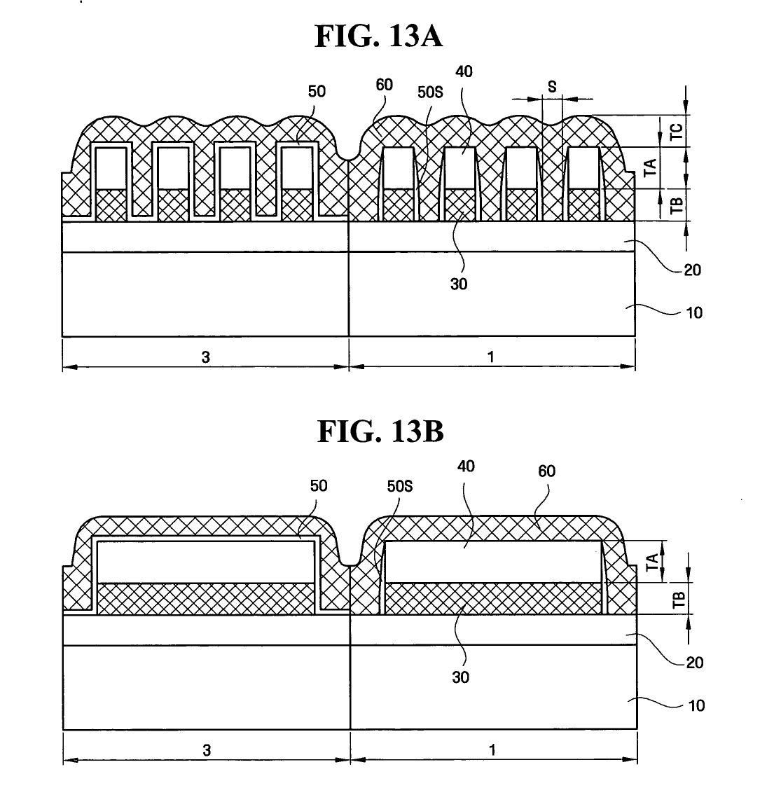

Referring to FIGS. 13A and 13B, a conductive film 60, used to form the complementary resistors, may be formed on an entire surface of the resultant structure, in which the resistors 30 are formed. The conductive film 60 may be made of a material with substantially the same resistivity as a material constituting the resistors 30. For example, when the resistors 30 are formed as doped polysilicon films, the conductive film 60 may be formed as a polysilicon film doped to the same concentration. To more effectively perform a subsequent etch-back process, the thickness TC of the conductive film 60 may satisfy Equation 3:
TB<TC<TA and 2×S<TC [Equation 3]
where TA is the thickness of the insulating mask 40, TB is the thickness of the resistors 30 and S is the dimension of the space between the resistors 30.

That is, the thickness TC of the conductive film 60 may be larger than the thickness TB of the resistors 30 and complementary resistors to be formed and smaller than the thickness TA of the insulating mask 40, and at the same time may be more than twice (2×) a dimension of space S between the resistors 30. It may thus be possible to prevent problems associated with an incomplete etch-back process. That is, it may be possible to avoid unwanted etch-back remainders in a subsequent etch-back step and/or avoid a conductive spacer remaining on sidewalls of the resistors 30. An interpretation of Equation 3 also implies that the insulating mask 40 have a thickness of 2 S or greater.

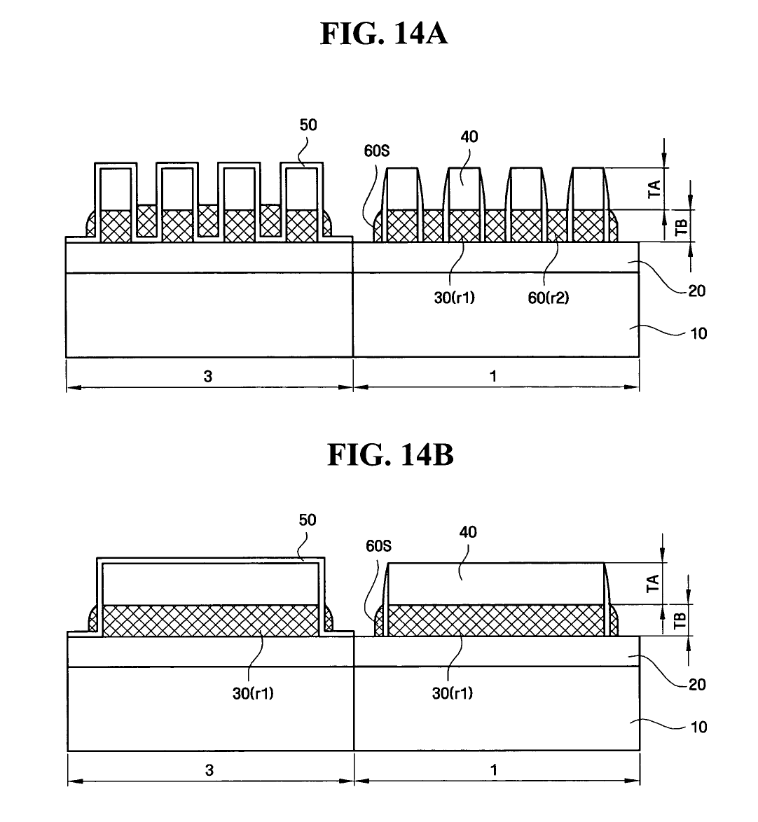

Complementary resistors may be formed in spaces defined between the resistors 30, so as to be electrically insulated from and parallel to the resistors. Referring to FIGS. 14A and 14B, the conductive film 60 formed on the entire surface of the substrate 10 may be subjected to an etch-back process. The etch-back process may be performed by, e.g., a plasma etching technique using an etching gas. The etching gas may include, e.g., HBr, Cl₂, CClF₃, CCl₄, NF₃, SF₆, etc. Through the etch-back process, complementary resistors 60 may be formed to substantially the same height as the resistors 30. Here, the complementary resistors 60 may be connected via a conductive spacer 60S remaining on sidewalls of the insulating spacer 50S or on the capping insulating film 50 of the outermost resistors and on lengthwise opposite ends of the resistors 30. The conductive spacer 60S may act as a parasitic resistor.

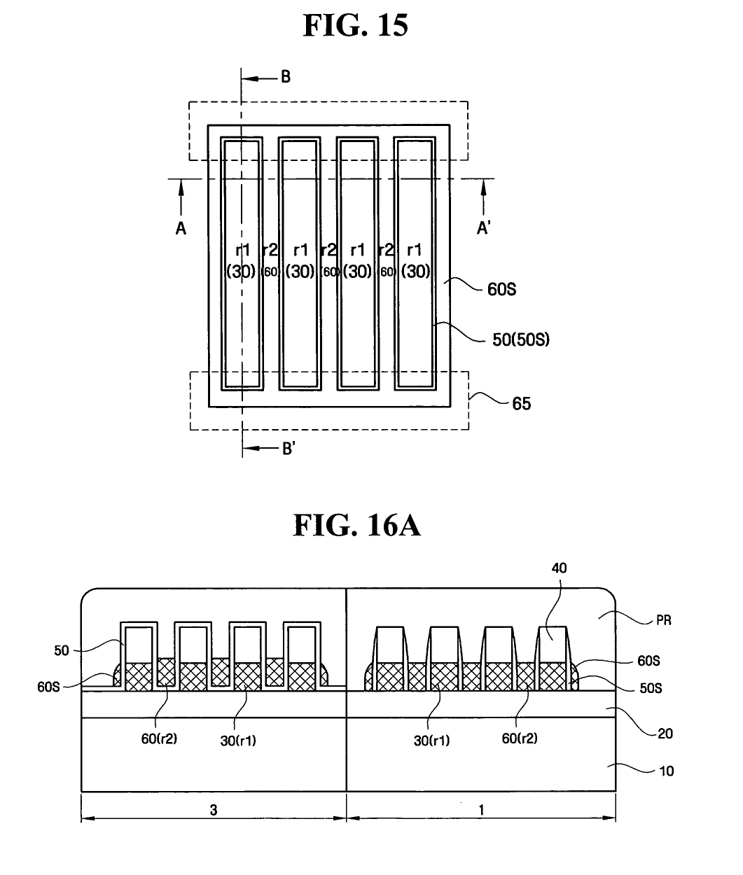

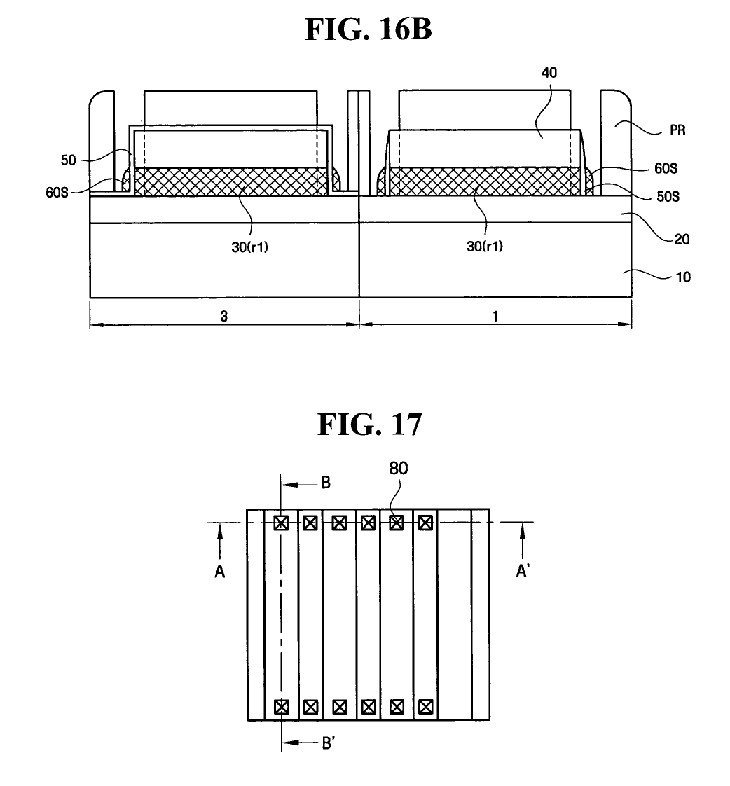

FIG. 15 illustrates a plan view of a mask 65 that may be used in an opening process for separation of the complementary resistors 60 and for removal of the parasitic resistance. FIGS. 16A and 16B illustrate cross-sectional views taken along lines A-A′ and B-B′ of FIG. 15.

A photoresist pattern PR may be formed on a front surface of the substrate 10 in which the etch-back process is completed, using the mask 65 for partially exposing lengthwise opposite ends of the resistors 30. In some cases, where an interlayer insulating film may be formed for compensation of step-to-step differences, the photoresist pattern PR may also be formed on the interlayer insulating film. The conductive spacer 60S, formed on lengthwise opposite ends of the resistors 30 and the complementary resistors 60, may be removed by using the photoresist pattern PR as an etching mask, thereby forming the complementary resistors 60, which are individually electrically insulated from the resistors 30.

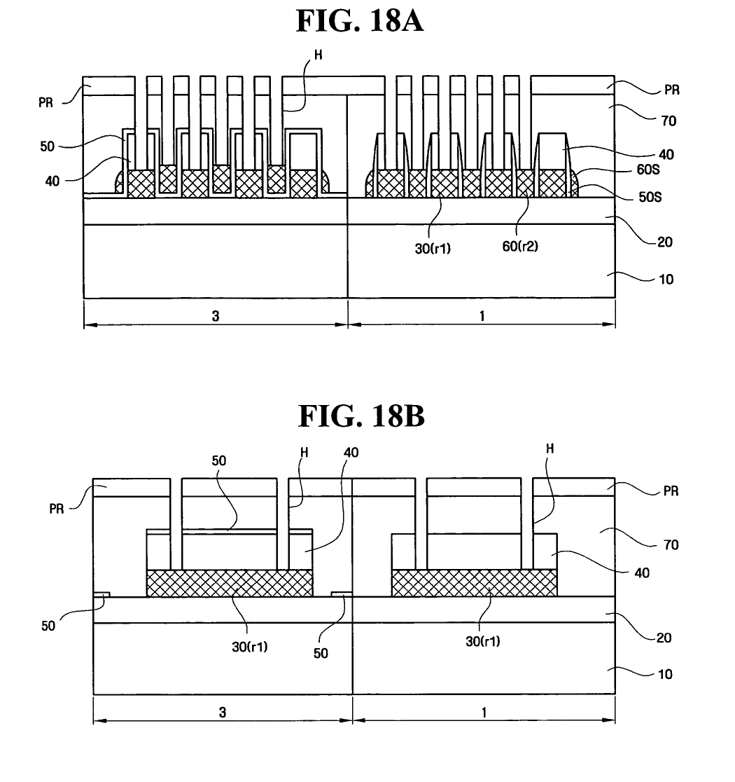

Wires for connecting the resistors in parallel with their adjacent complementary resistors may be formed to complete fabrication of resistor elements. FIG. 17 illustrates a plan view of parallel-connection contacts 80, and FIGS. 18A and 18B illustrate cross-sectional views taken along lines A-A′ and B-B′ of FIG. 17.

An interlayer insulating film 70 may be formed on the entire surface of the substrate 10 and then a photoresist pattern PR for formation of the parallel-connection contacts 80 may be formed on the interlayer insulating film 70. The interlayer insulating film 70 and the insulating mask 40 may be etched, using the photoresist pattern PR as an etching mask, to form parallel-connection contact holes H. In the third embodiment, the capping insulating film 50 may also be etched. The parallel-connection contact holes H may be formed on lengthwise opposite ends of the resistors 30 and the complementary resistors 60. Here, one of the outermost resistors may be a dummy resistor, in which no parallel-connection contact holes need be formed.

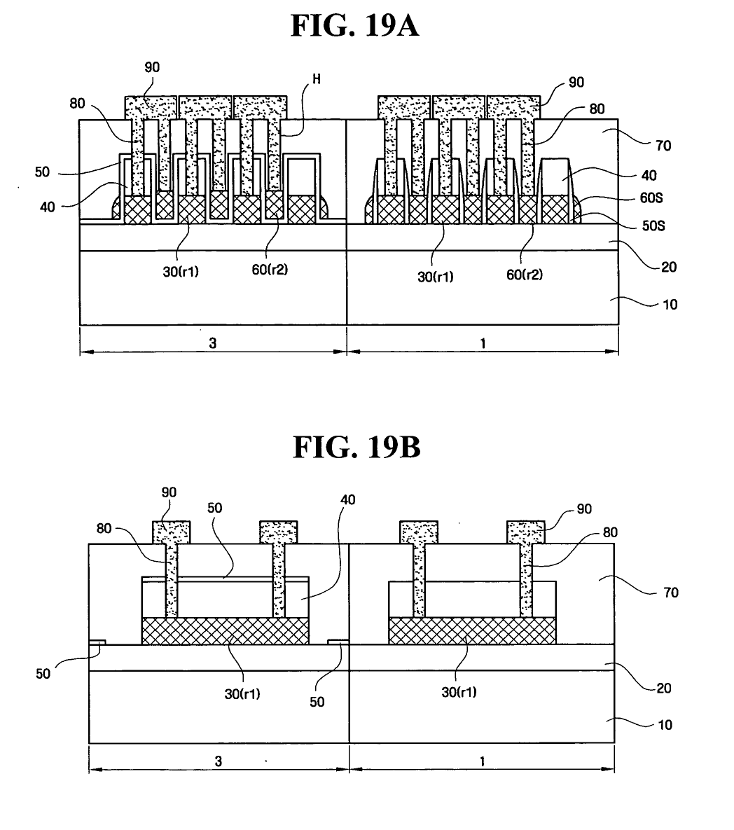

Referring to FIGS. 19A and 19B, the parallel-connection contact holes H may be filled with a conductive film to form the parallel-connection contacts 80. Then, a conductive film may be formed on the parallel-connection contacts 80 to form parallel-connection node wires 90, which connect the resistors 30 and their adjacent complementary resistors 60, to complete three resistor elements.

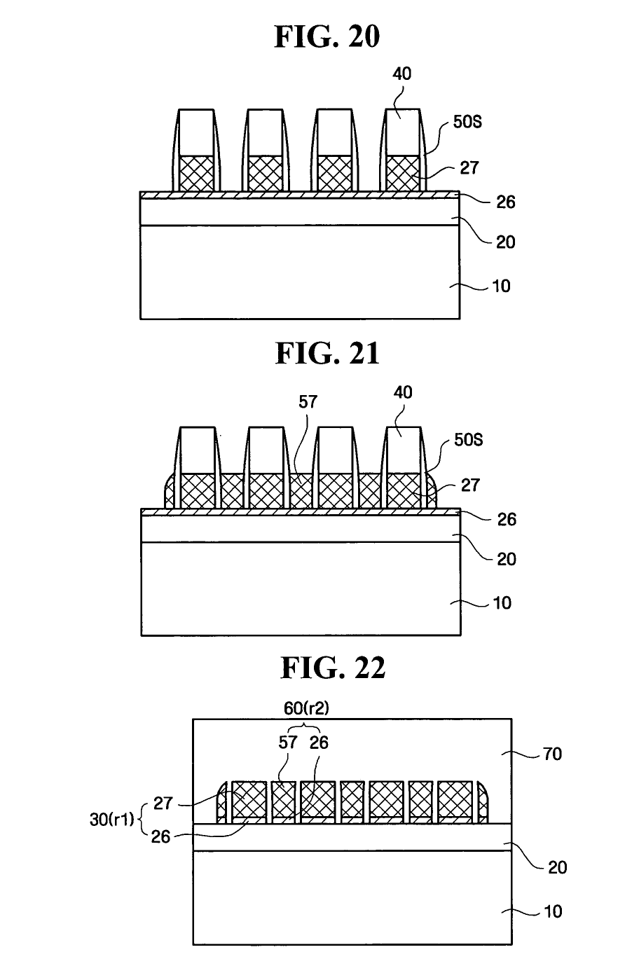

FIGS. 20 through 22 illustrate cross-sectional views of stages in a method of fabricating resistor elements, according to the fourth embodiment of the present invention.

Referring to FIG. 20, a first lower conductive film may be formed on an insulating layer 20 covering a substrate 10. Then, a first upper conductive film and a mask insulating film may be sequentially formed on the first lower conductive film and patterned to form a first upper conductive film pattern 27 and an insulating mask 40, respectively. The first lower conductive film may be, e.g., Ti, TiN, etc., and the first upper conductive film may be, e.g., a doped polysilicon film.

Referring to FIG. 21, a second conductive film may be deposited and etched back, as described above in the fabricating method of the first embodiment, to form a second conductive film pattern 57. Then, lengthwise opposite ends of the first upper conductive film pattern 27 and the second conductive film pattern 57 may be subjected to an opening process and then etched, thereby forming the second conductive film pattern 57 as a discrete element and removing a parasitic resistance.

Referring to FIG. 22, an insulating spacer 50S may be selectively removed, e.g., by wet etching. Then, the first lower conductive film may be etched, using the first upper conductive film pattern 27 and the second conductive film pattern 57 as etching masks, to thus complete resistors 30, which may include the first upper conductive film pattern 27 and a first lower conductive film pattern 26, and complementary resistors 60, which may include the second conductive film pattern 57 and the first lower conductive film pattern 26. Optionally, the opening process of the lengthwise opposite ends of the resistors 30 and the complementary resistors 60 may be preceded by etching the first lower conductive film.

Thus, the resistors 30 and the complementary resistors 60 may have the same structure, i.e., a two conductive layer structure. An interlayer insulating film 70 may be formed to electrically insulate the resistors 30 and the complementary resistors 60. The interlayer insulating film 70 may be made of a material with good gap filling property to efficiently fill spaces between the resistors 30 and the complementary resistors 60. For example, the interlayer insulating film 70 may be formed as a high-density plasma oxide film. Finally, parallel-connection contacts and parallel-connection node wires may be formed in the same manner as in the first embodiment.

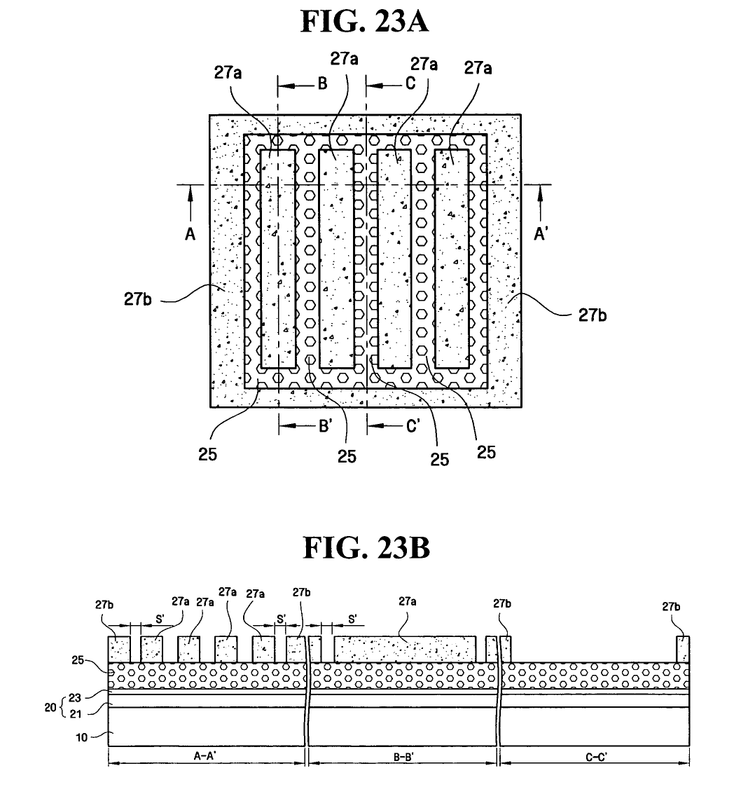

A method of fabricating the resistor elements according to the fifth embodiment of the present invention will now be described with reference to sequential plan views in FIGS. 23A, 24A, 25A and 26A and corresponding sequential cross-sectional views in FIGS. 23B, 24B, 25B and 26B.

Referring to FIGS. 23A and 23B, an insulating layer 20 and a mold insulating film 25 may be sequentially formed on a substrate 10. The insulating layer 20 may include a first insulating layer 21 and a second insulating layer 23. The second insulating layer 23 may be made of a material with good etching selectivity relative to the mold insulating film 25, so that the second insulating layer 23 may be used as an etch stop layer during etching of the mold insulating film 25. For example, the first insulating layer 21 and the mold insulating film 25 may be oxide films and the second insulating layer 23 may be a nitride film. A photoresist pattern defining a mold pattern may be formed on the mold insulating film 25. The photoresist pattern may include a bar pattern 27a, having the same shape as resistors to be formed, and a frame pattern 27b, spaced a predetermined distance S′ apart from, and enclosing, the bar pattern 27a.

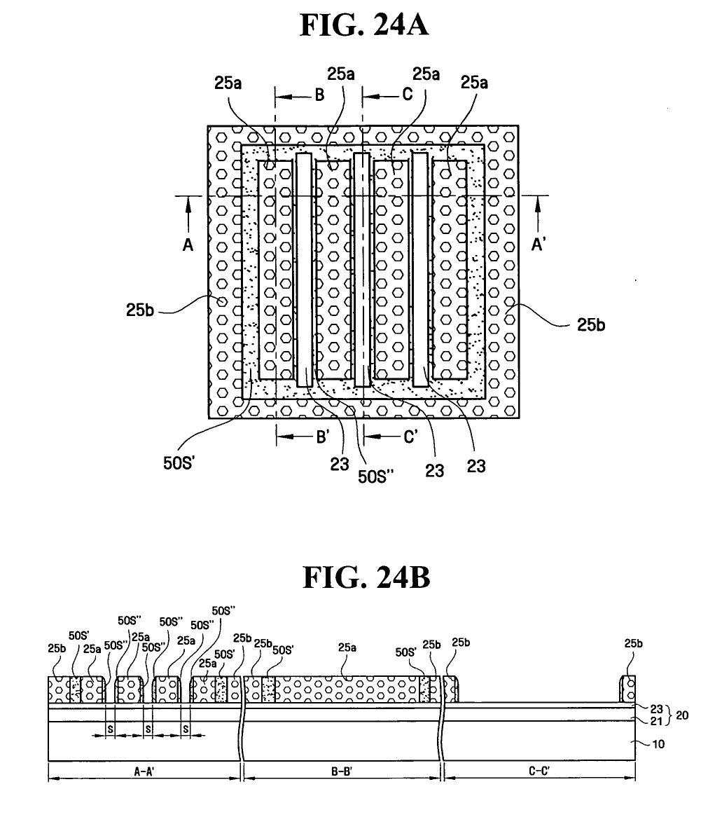

Referring to FIGS. 24A and 24B, the mold insulating film 25 may be etched, e.g., using the photoresist pattern (27a, 27b) as an etching mask, to form a bar pattern mold 25a and a frame pattern mold 25b. After removing the photoresist pattern (27a, 27b), an insulating film with etching selectivity to the bar pattern mold 25a and the frame pattern mold 25b may be formed on an entire surface of the substrate 10. If the bar pattern mold 25a and the frame pattern mold 25b are formed as oxide films, the insulating film may be formed as a nitride film. The insulating film may be formed to such a thickness that a space S′ (shown in FIG. 23B) between the bar pattern mold 25a and the frame pattern mold 25b is fully filled. For example, when the space S′ between the bar pattern mold 25a and the frame pattern mold 25b is 50 nm, the insulating film may be formed to a thickness of 25 nm or greater. When the insulating film is etched back, a first insulating spacer 50S′, which may fill the space S′ between the bar pattern mold 25a and the frame pattern mold 25b, and a second insulating spacer 50S″, which may define spaces for forming complementary resistors, may be formed.

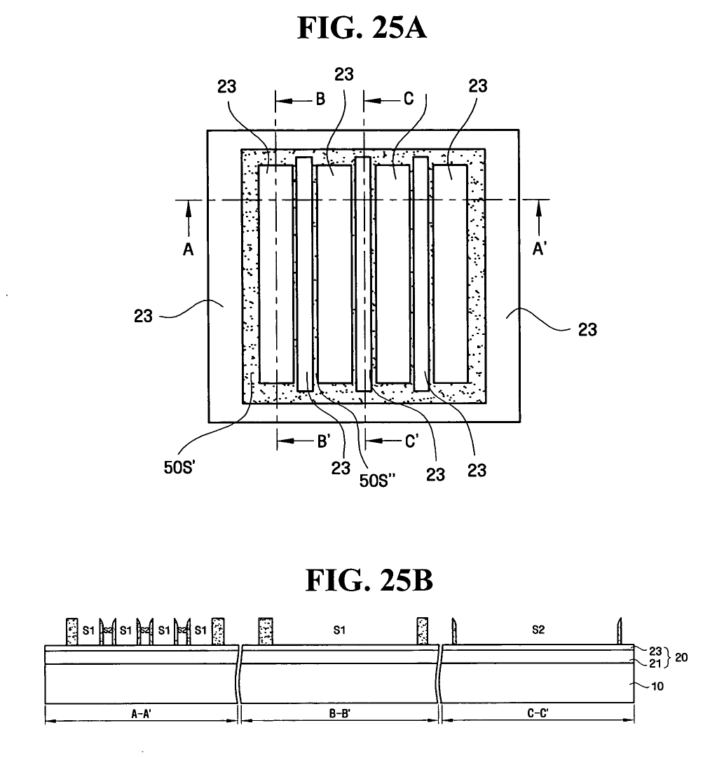

Referring to FIGS. 25A and 25B, the bar pattern mold 25a and the frame pattern mold 25b may be removed. As a result, a plurality of bar-shaped spaces S1 and S2 may be defined by the first and second insulating spacers 50S′ and 50S″. The removal of the bar pattern mold 25a and the frame pattern mold 25b may be performed by various methods, e.g., an etch-back process, a wet etching process, etc.

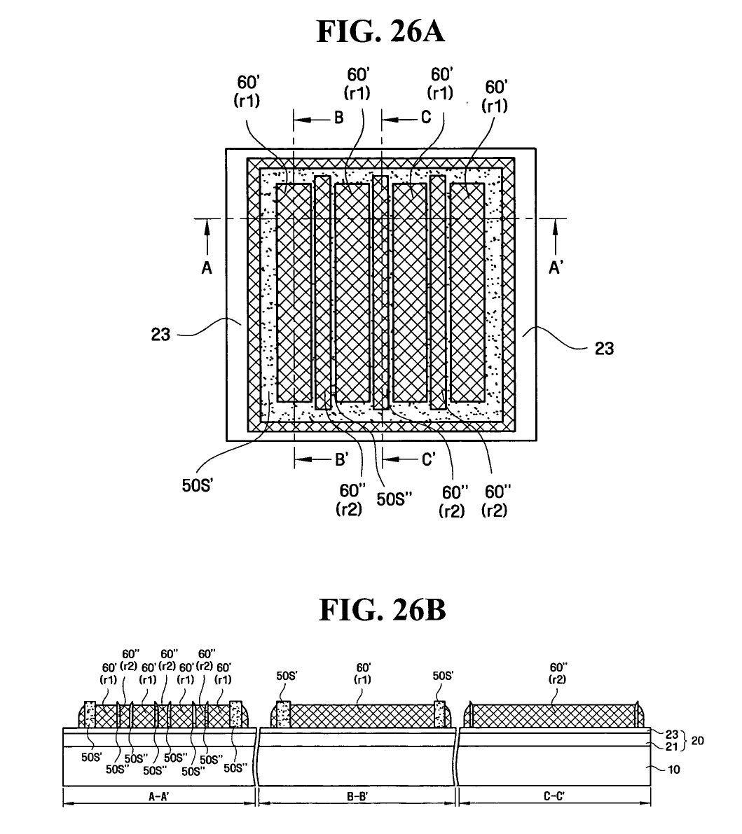

Referring to FIGS. 26A and 26B, after the removal of the bar pattern mold 25a and the frame pattern mold 25b, a conductive film may be formed on the entire surface of the resultant structure, in which the first and second insulating spacers 50S′ and 50S″ remain. The conductive film may then be etched back to thus simultaneously form resistors 60′ (r1) and complementary resistors 60″ (r2).

Next, an interlayer insulating film (see 70 of FIG. 10), parallel-connection contacts (see 80 of FIG. 10), and parallel-connection node wires (see 90 of FIG. 10) may be formed in the same manner as in the first embodiment. Thus, resistor elements according to the fifth embodiment, shown in FIGS. 9 and 10, may be fabricated.

In the resistor element fabricating method according to the fifth embodiment of the present invention, the resistors r1 and the complementary resistors r2 may be simultaneously formed through one step of forming a conductive film. Therefore, process variation dependency of resistor element resistance may be reduced or eliminated (process variation dependency of resistor element resistance may result from separate conductive film formation processes for resistors and complementary resistors). Since the resistors r1, the complementary resistors r2 and a conductive spacer (see 60S of FIGS. 9 and 10) may be electrically insulated by the first and second insulating spacers 50S′ and 50S″, no additional step for electrical insulation may be needed, in contrast to the first through fourth embodiments.

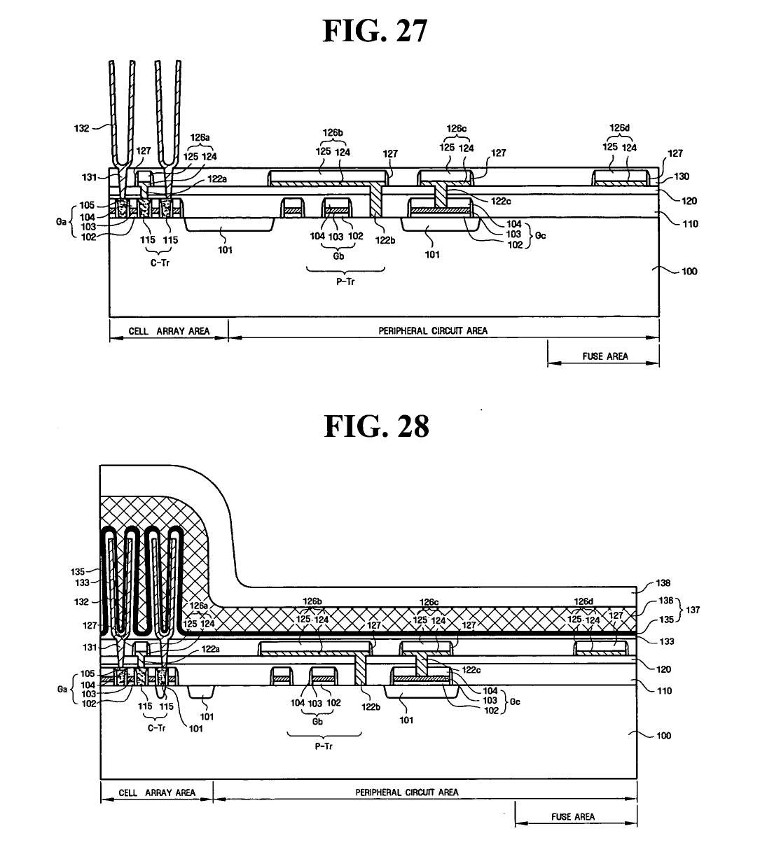

Hereinafter, methods of fabricating a semiconductor integrated circuit device including a resistor element according to embodiments of the present invention will be described with reference to FIGS. 27 through 32.

Semiconductor IC devices, in which resistor elements and fabrication methods thereof according to the present invention can be applied, may include, e.g., highly integrated semiconductor memory devices such as dynamic random access memories (DRAMs), static random access memories (SRAMs), flash memories, ferroelectric-RAMs (FRAMs), magnetic-RAMs (MRAMs), and phase-change RAMs (PRAMs), microelectro-mechanical systems (MEMSs), optoelectronic devices, display driver ICs, processors such as central processing units (CPUs) and digital signal processors (DSPs), etc.

Hereinafter, methods of fabricating DRAMs as semiconductor IC devices will be illustratively described. Fabrication of resistor elements according to embodiments of the present invention may be performed simultaneously with formation of plate electrodes of cell capacitors of DRAMs. DRAMs may be generally fabricated by processes commonly known in those skilled in the art, in view of the methods for fabricating resistor elements according to the present invention. A method of fabricating a DRAM will be described herein schematically. By way of example, fabrication of resistor elements including a capping insulating film, like in the third embodiment of the present invention, and three dummy resistors, like in the second embodiment of the present invention, will be described.

Referring to FIG. 27, a substrate 100 including active regions defined by a device isolation region 101 may be prepared. The device isolation region 101 may be formed as a shallow trench isolation (STI) region. The STI region may be formed, e.g., by forming a shallow trench to a depth of about 3,000-4,000 Å in the substrate 100, followed by filling the shallow trench with an oxide film with good filling characteristics and planarization. The substrate 100 may be, e.g., a p-type substrate. Cell transistors C-Tr and peripheral circuit transistors P-Tr may be formed in a cell array area and a peripheral circuit area, respectively, of the substrate 100. The transistors C-Tr and P-Tr may be formed by, e.g., a conventional complementary metal oxide semiconductor (CMOS) process. In detail, well regions (not shown) may be formed by ion implantation of n- or p-type impurities. A gate insulating film 102, a stacked conductive film 103 including a doped polysilicon film and a tungsten silicide film, and a capping insulating film 104 may be sequentially deposited and patterned into gate electrodes Ga, Gb and Gc. Ions for formation of low-concentration source/drain regions (not shown) and ions for formation of halo regions (not shown) may be implanted. A spacer 105 may be formed on sidewalls of the gate electrodes Ga, Gb and Gc and ions for formation of high-concentration source/drain regions (not shown) may be implanted to form the cell transistors C-Tr and the peripheral circuit transistors P-Tr.

Next, a first interlayer insulating film 110 may be formed on the entire surface of the substrate 100 using, e.g., a material with good step coverage characteristics. Then, landing pads 115, which may be self-aligned by the gate electrode Ga and the spacer 105 and which may be connected to source and drain regions of the cell transistors C-Tr, may be formed in the first interlayer insulating film 110. The landing pads 115 may be made of, e.g., doped polysilicon, etc.

Next, a second interlayer insulating film 120 may be formed using high-density plasma oxide and then etched using, e.g., an anisotropic etch process, to form a plurality of contact holes. The contact holes may be filled with a diffusion barrier material, e.g., TiN, and a metal material, e.g., W, and planarized to thus form a bit line contact 122a, which may be connected to the landing pads 115 (connected, in turn, to drain regions of the cell transistors C-Tr), a peripheral circuit contact 122b, which may be connected to the drain region of the peripheral circuit transistor P-Tr, and a cell pad contact 122c.

Next, a bit line 126aconnected to the bit line contact 122a, a wire 126b connected to the peripheral circuit contact 122b, a wire 126c connected to the cell pad contact 122c and a fuse 126d of a fuse area may be formed. The bit line 126a, the wires 126b and 126c and the fuse 126d may include a conductive film 124 and a hard mask 125. The conductive film 124 may include a diffusion barrier film made of, e.g., TiN, etc. and a metal film made of, e.g., W, etc. A sidewall spacer 127 may be formed on sidewalls of the bit line 126a, the wires 126b and 126c and the fuse 126d.

After forming the bit line 126a, a third interlayer insulating film 130 may be formed. A storage node contact 131 connected to the landing pads 115, which may be connected to the source regions of the cell transistors C-Tr, may be formed in the third interlayer insulating film 130. The storage node contact 131 may be made of, e.g., doped polysilicon, etc. Then, a storage electrode 132 connected to the storage node contact 131 may be formed. The storage electrode 132 may be formed in a single cylinder shape using, e.g., doped polysilicon, etc.

Referring to FIG. 28, a dielectric film 133 may be formed on the entire surface of the substrate 100 on which the storage electrode 132 is formed. A conductive film 137, intended for formation of a plate electrode and resistors, may be formed. The conductive film 137 may be a single doped polysilicon film. Alternatively, the conductive film 137 may be a stacked film including, e.g., a diffusion barrier film 135 and a doped polysilicon film 136, as shown in FIG. 28. The diffusion barrier film 135 may be formed to a thickness of about 300-400 Å by, e.g., chemical vapor deposition (CVD) using TiN. The doped polysilicon film 136 may be formed to a thickness of about 2,000-3,000 Å at a temperature of about 600-700° C. by, e.g., low pressure CVD (LPCVD) using a reaction gas such as SiH₄ or Si₂H₆ and a doping gas such as PH₃. An insulating film 138 for forming hard mask may be formed on the conductive film 137. Before or after formation of the mask insulating film 138, an annealing process may be performed. The mask insulating film 138 may be made of a material that can efficiently serve as a hard mask and has high etching selectivity to an insulating spacer (to be formed in a subsequent process). For example, the mask insulating film 138 may be a thermal oxide film made of middle temperature oxide (MTO) or high temperature oxide (HTO).

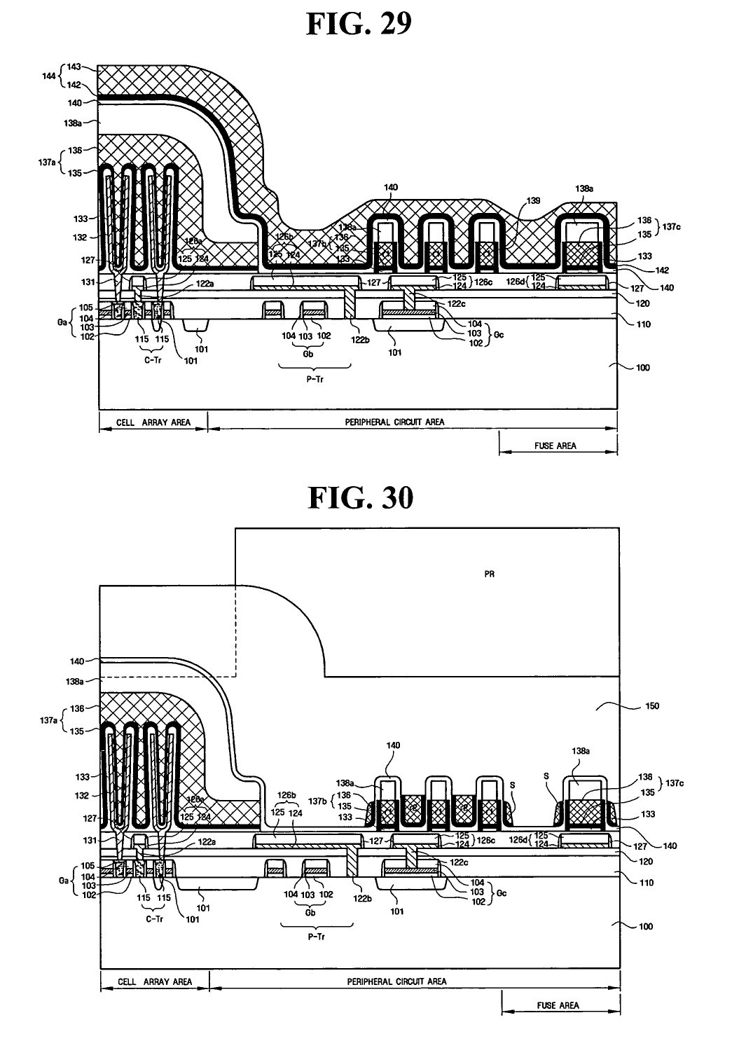

Referring to FIG. 29, the insulating film 138 and the conductive film 137 may be patterned to form a cell plate electrode 137a and resistors 137b (r1), including insulating masks 138a thereon. A conductive pattern 137c serving as an etch stop layer may be formed in the fuse area. A capping insulating film 140, enclosing the resistors r1 and the insulating masks 138a, and a conductive film 144 may be sequentially formed. The conductive film 144 may be made of a material with the same resistivity as the conductive film 137 that constitutes the resistors r1. The conductive film 144 may be formed so as to satisfy the requirements of Equation 3, above. If the conductive film 144 includes a TiN film 142 and a doped polysilicon film 143, as shown in FIG. 29, a TiN film 139 may be further formed on sidewalls of the resistors r1 before the formation of the capping insulating film 140, so that the resistors r1 have the same structure as the complementary resistors, which are to be formed in a subsequent process. The TiN film 139 may be formed on the sidewalls of the resistors r1 by, e.g., forming a TiN film on the entire surface of the substrate 100 and then etching-back the TiN film.

Referring to FIG. 30, the conductive film 144 may be etched back using, e.g., HBr, Cl₂, CClF₃, CCl₄, NF₃, SF₆, etc., as a main etch gas, to form complementary resistors r2. A fourth interlayer insulating film 150 may be formed and an opening process may be performed to reduce a step-to-step difference between the cell array area and the peripheral circuit area, individually separate the complementary resistors r2 and completely separate the complementary resistors r2 from the resistors r1. In detail, the fourth interlayer insulating film 150 may be formed to a thickness of about 15,000-20,000 Å using, e.g., plasma enhanced tetraethylorthosilicate (PETEOS) to fully remove a step-to-step difference. A photoresist pattern PR may be formed so as to expose the cell array area and portions of lengthwise opposite ends of the resistors r1. An opening process may be performed using the photoresist pattern PR as an etching mask so that the fourth interlayer insulating film 150, the capping insulating film 140, and the insulating mask 138a in the cell array area are etched to reduce a step-to-step difference, and conductive spacers S on lengthwise opposite ends of the resistors r1 and on lengthwise opposite ends and sidewalls of the complementary resistors r2 are etched to individually electrically insulate the complementary resistors r2 from the resistors r1. The fourth interlayer insulating film 150, the capping insulating film 140 and the mask insulating film 138 may be etched using an etch gas such as CF₄, CHF₃ or C₄F₈, and the conductive spacers S on lengthwise opposite ends of the resistors r1 and on lengthwise opposite ends and sidewalls of the complementary resistors r2 may be etched using an etch gas such as HBr, Cl₂, CClF₃, CCl₄, NF₃ or SF₆. The photoresist pattern PR may be removed, and the fourth interlayer insulating film 150 remaining on a boundary between the cell array area and the peripheral array area may be removed by, e.g., a chemical mechanical polishing (CMP) process.

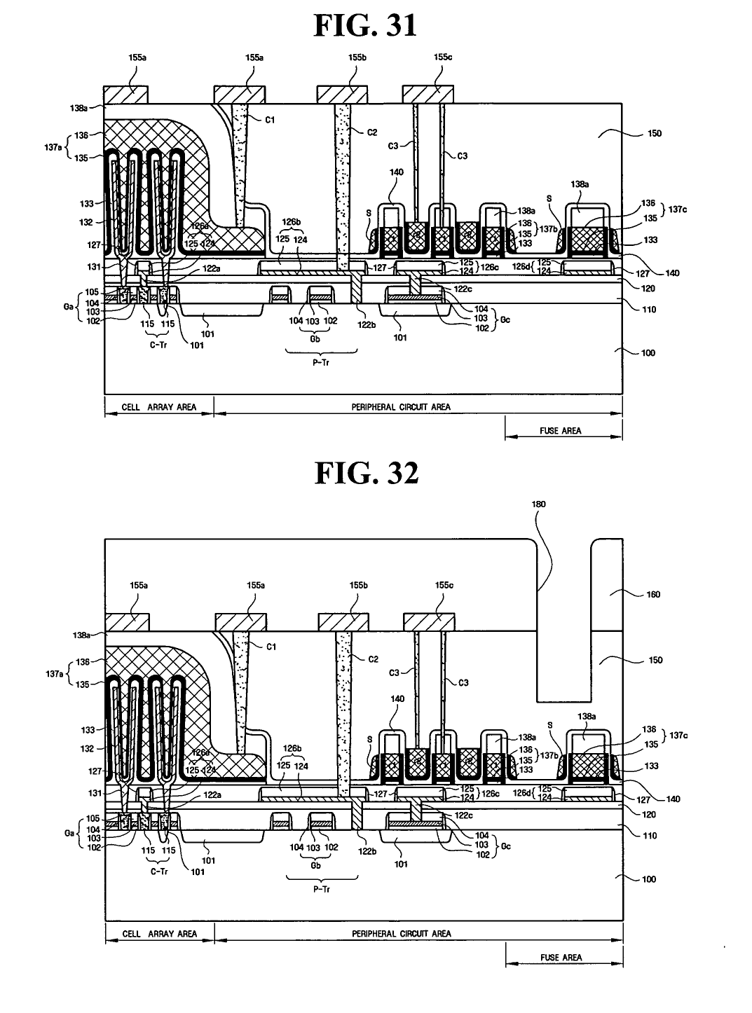

Referring to FIG. 31, an interlayer insulating film (not shown) may be formed to compensate for any damage caused by CMP and to cover regions exposed in the opening process for the formation of the complementary resistors r2, which are individually electrically insulated from the resistors r1. A plate contact C1 (connected to the plate electrode 137a), a peripheral circuit contact C2 (connected to a peripheral circuit device), and a parallel-connection connection contact C3 (to connect the resistors r1 and the complementary resistors r2 in parallel) may be formed at the same time. The plate contact C1, the peripheral circuit contact C2 and the parallel-connection contact C3 may be made of a diffusion barrier material, e.g., TiN and a metal material, e.g., W. A conductive film may be formed as a single film, or as a combination film of two or more films, and may include, e.g., Al, Ti, W, Ti/Al, TiN/Al or TiN/Al/TiN. The conductive film may be patterned to form first level metal wires 155a, 155b and 155c (155c is referred to as “parallel-connection node wire”) connected to the plate contact C1, the peripheral circuit contact C2, and the parallel-connection contact C3, respectively, to complete a resistor element.

FIG. 31 illustrates a resistor element including a connection between an inner resistor, which may be relatively insensitive to loading effect, and its adjacent complementary resistor, with two outermost resistors and one complementary resistor adjacent to one of the two outermost resistors used as dummy resistors. The number of dummy resistors may vary according to a process type. In the illustrative embodiment, the parallel-connection node wire 155c may be formed as a first metal wire. However, it will be understood that the parallel-connection node wire 155c may be formed as a higher level metal wire than the first level wire.

Further aspects, which are not shown, may include one or more of the following: after the formation of the first level metal wires 155a and 155b and the parallel-connection node wire 155c, vias and multi-layer metal wires (e.g., second metal wire, third metal wire, etc.) may be formed, a guard ring pattern film may be formed in the fuse area and a passivation film may be formed followed by a fuse opening process and a pad opening process.

As disclosed above, an opening process for separation of the resistors r1 and the complementary resistors r2 may be performed simultaneously with a cell array area opening process. However, if the cell array area opening process is omitted, an opening process for separation of the resistors r1 and the complementary resistors r2 may be performed by, e.g., separating the resistors r1 and the complementary resistors r2 using separate masks prior to the formation of the parallel-connection contact C3.

Alternatively, an opening process for separation of the resistors r1 and the complementary resistors r2 may also be performed simultaneously with a fuse opening process, as illustrated in FIG. 32. Referring to FIG. 32, multi-layer metal wires (not shown) may be formed on the first metal wires 155a and 155b and the parallel-connection node wire 155c, a passivation film 160 may be formed and then a window 180 for exposing the fuse area may be formed. Process control may be easier if the material layers to be removed in the fuse area and a resistor element area are the same.

While methods of fabricating semiconductor IC devices have been illustrated in terms of simultaneous formation of a resistor element and a plate electrode of a DRAM, formation of a resistor element may also be performed simultaneously with formation of the bit line 126a before the formation of the storage electrode 132.

Furthermore, it will be understood by those of ordinary skill in the art that various methods of fabricating resistor elements according to embodiments of the present invention may be performed. For example, if the method of fabricating the resistor element according to the fifth embodiment of the present invention is applied to fabrication of a semiconductor IC device, formation of first and second insulating spacers (see 50S′ and 50S″ of FIGS. 25A and 25B) may be performed before the formation of the plate electrode 137a and then the resistors r1 and the complementary resistors r2 may be formed at the same time using a conductive film for the plate electrode 137a.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A resistor element comprising:
a resistor formed on an insulating layer; and
a complementary resistor formed on the insulating layer and insulated from the resistor, the complementary resistor electrically connected in parallel to the resistor,
wherein a resistance of the complementary resistor is complementary to a resistance of the resistor.

2. The resistor element as claimed in claim 1, wherein the complementary resistor is adjacent to the resistor.

3. The resistor element as claimed in claim 2, wherein the complementary resistor and the resistor are formed of materials having substantially the same resistivity, such that a variation in a width of the resistor produces a complementary variation in a width of the complementary resistor but does not produce a variation in resistance of the resistor element.

4. A semiconductor device comprising a plurality of resistor elements, the plurality of resistor elements including:
resistors formed on an insulating layer and separated from each other by a constant pitch; and
complementary resistors formed adjacent to the resistors, wherein each complementary resistor has a width that is complementary to a width of an adjacent resistor and is electrically connected in parallel to the adjacent resistor.

5. The semiconductor device as claimed in claim 4, wherein each of the plurality of resistor elements includes a resistor and a complementary resistor having substantially the same resistivity.

6. The semiconductor device as claimed in claim 4, wherein each of the plurality of resistor elements includes a resistor and a complementary resistor having substantially the same height.

7. The semiconductor device as claimed in claim 4, wherein each of the plurality of resistor elements includes a resistor and a complementary resistor having substantially the same length.

8. The semiconductor device as claimed in claim 4, wherein each of the plurality of resistor elements includes a resistor and a complementary resistor that are electrically connected in parallel by way of contact holes formed at lengthwise opposite ends of the resistor and the complementary resistor.

9. The semiconductor device as claimed in claim 4, further comprising a conductive spacer encircling and insulated from the plurality of resistor elements.

10. The semiconductor device as claimed in claim 4, further comprising a dummy resistor formed adjacent to a complementary resistor, wherein the dummy resistor does not constitute a resistor element.

11. The semiconductor device as claimed in claim 4, further comprising two outermost resistors and at least one complementary resistor adjacent to one of the two outermost resistors, wherein the two outermost resistors and at least one complementary resistor adjacent to one of the two outermost resistors are dummy resistors that do not constitute a resistor element.

12. A semiconductor integrated circuit device comprising:
a semiconductor substrate having a cell array area and a peripheral circuit area; and
a plurality of resistor elements formed on an insulating layer of the peripheral circuit area, the plurality of resistor elements including:
resistors separated from each other by a constant pitch; and
complementary resistors formed adjacent to the resistors, wherein each complementary resistor has a width that is complementary to a width of an adjacent resistor and is electrically connected in parallel to the adjacent resistor.

13. The semiconductor integrated circuit device as claimed in claim 12, wherein the cell array area further comprises a cell capacitor, and wherein a plate electrode of the cell capacitor and the resistors and/or the complementary resistors are formed on a same interlayer insulating film.

14. The semiconductor integrated circuit device as claimed in claim 12, wherein each of the plurality of resistor elements includes a resistor and a complementary resistor having substantially the same length.

15. The semiconductor integrated circuit device as claimed in claim 12, wherein each of the plurality of resistor elements includes a resistor and a complementary resistor that are electrically connected in parallel by way of contact holes formed at lengthwise opposite ends of the resistor and the complementary resistor.

16. The semiconductor integrated circuit device as claimed in claim 12, further comprising a conductive spacer encircling and insulated from the plurality of resistor elements.

17. The semiconductor integrated circuit device as claimed in claim 12, further comprising a dummy resistor formed adjacent to a complementary resistor, wherein the dummy resistor does not constitute a resistor element.

18. The semiconductor integrated circuit device as claimed in claim 12, further comprising two outermost resistors and at least one complementary resistor adjacent to one of the two outermost resistors, wherein the two outermost resistors and at least one complementary resistor adjacent to one of the two outermost resistors are dummy resistors that do not constitute a resistor element.

19. A method of fabricating a resistor element, the method comprising:
providing a substrate having an insulating layer thereon; and
forming a plurality of resistor elements, the plurality of resistor elements including:
resistors formed on the insulating layer and separated from each other by a constant pitch; and
complementary resistors formed adjacent to the resistors, wherein each complementary resistor has a width that is complementary to a width of an adjacent resistor and is electrically connected in parallel to the adjacent resistor.
